(19) United States
(12) Patent Application Publication
(10) Pub. No.: US 2005/0240379 A1
(43) Pub. Date: Oct. 27, 2005

(54) Project system and method

(76) Inventor: W. Frank Little, Magnolia, TX (US)

Correspondence Address: Alton W. Payne, Suite 200, 5001 Bissonnet, Bellaire, TX, 77401, US

(21) Appl. No.: 10/677,905

(22) Filed: Oct. 2, 2003

Related U.S. Application Data
(63) Continuation of application No. 09/431,040, filed on Oct. 30, 1999, now abandoned.

(51) Int. Cl. G06F 17/50

(52) U.S. Cl. 703/1

(57) ABSTRACT

A system for creating a project (including a building, facility, or product) is disclosed. The system comprises two classifications of assets or items: a Building Component which is either inherently permanent or necessary for the operation or maintenance of the building; and an Architectural Element which is either removeable, reuseable, relocatable, decorative or supplemental. A method of creating a project (including a building, facility or product) using Building Components and Architectural Elements is also provided. Further, a method of classifying and/or documenting assets associated with a project (including a building, facility or product) using Building Components and Architectural Elements is provided. The method of classifying and/or documenting assets comprising the steps of determining if the asset is permanent, determining if the asset is relocatable, determining if the asset is necessary, determining if the asset is decorative, determining if the asset is supplemental, and conducting a factual analysis of the tangible and intangible characteristics of the asset for verifying the classification of the asset. The present invention provides that the Architectural Elements can be reconfigured for improving user efficiency, enhancing facility management, reducing construction cost and time, simplifying remodeling construction thereby allowing projects to be rehabilitated that would otherwise be demolished, reducing the employee down-time associated with building remodeling construction and maintenance, reducing the building down-time because remodeling can be done more quickly with less demolition, noise, waste or delay, and at least one of separating and identifying the Architectural Elements during the pre-design, design, documentation, implementation, audit or after-life to accommodate future changes in environmentally sensitive or ecologically beneficial manners.

### CROSS REFERENCE TO RELATED APPLICATION

This application is a continuation application of and claims the benefit of U.S. patent application Ser. No. 09/431,040 entitled “Project System and Method,” filed Oct. 30, 1999.

### FIELD OF THE INVENTION

This invention is in the field of project creation and includes project design, documentation, construction, implementation, use, reuse, alternate use, and after-life waste. Projects include buildings, facilities, or products. The present invention uses building components and architectural elements. Building Components are defined as components that are inherently permanent, or components that are necessary for the operation or maintenance of the building. Architectural Elements are defined as elements that are removeable, reuseable, relocatable, decorative or supplemental.

### BACKGROUND OF THE INVENTION

The life of a project includes many phases, for example, conception to birth to death to burial. The typical project includes the following phases.

Pre-design—Initially, a project is conceived for a building, facility or product. The first phase of the project is referred to as pre-design and includes site analysis, Project Pro Forma (the analysis of the financial feasibility and related design of the project), program, and the like.

Design—Typically, after the pre-design phase, the Building Components of the project are designed. Building Components are items that are necessary for the operation or maintenance of the building or are inherently permanent. The design phase includes schematic design and design development of the project.

Documentation—Typically, after the design phase, the design is then documented and often further refined. The documentation phase includes working drawings, specifications, and construction contracts, and the like.

Pricing—Typically, after the documentation phase the project is priced or bid.

Implementation—Typically, after the pricing phase the project is implemented. Implementation includes construction administration, construction, installation, assembly, change orders, field orders, movers instructions, product warranties for facility management, occupancy, placed in service, use, and the like.

Audit—Typically, after implementation the building is audited for reporting purposes. An audit of Building Component costs may include some wrongly reported asset classifications. Cost recovery or cost segregation services audit the list of Building Component assets with their associated costs and identify assets that were wrongly reported with Building Components, and correct the error. A prior art audit may include cost segregation services but does not include coordinating with other professionals to conform or transform a Building Component into an Architectual Element. Cost segregation is the process of identifying assets that already exist in a building for accounting purposes only. Cost segregation separates personal property from real property. Personal property includes fixtures, furniture or equipment. Real property is generally considered to be inherently permanent and fixed to the land. Cost segregation is the segregation of just the costs, not the segregation of architects', engineers' or contractors' drawings, documents, specifications, products and the like. Cost segregation separates the costs of personal property assets from real property assets without coordinating or influencing the work or documents of the architect, designer, engineer, contractor, facility manager, product manufacturer and the like.

Abandonment—At some point in time the initial use or even the building itself is abandoned. Abandonment may include a study to determine the feasibility of an alternate use that usually requires partial or even full demolition. When alternate uses are determined unprofitable (usually because of elevated cost and complexity associated with remodel construction) the result is a vacant building that is characteristically a social and health hazard having a negative influence on neighborhood cohesion and welfare.

Demolition—Typically, next comes demolition. This is often necessary because our current building methods generally do not lend themselves to being “de-constructed” into segregated parts which could be reused. Therefore, the demolition of buildings, or parts of projects, is currently a process that destroys the integrity of the individual building components by compacting and compressing them into a composite mass.

Landfill/toxic waste—The demolished parts of a project must then be transported to a permitted burial site for landfill, some of which becomes toxic waste. This constitutes a health hazard and it adversely affects the environment. Separating the individual components from the compressed composite mass for recycle or subsequent use is often impractical at this point. Therefore, construction demolition of projects and their components become very low grade waste at best and more often become an environmental hazard requiring special landfill permits because, in its composite state, it produces off-gases and byproducts that are volatile and hazardous to the health safety and welfare of the public. The prior known projects methods result in undesirable characteristics including landfills, hazardous waste, energy waste, restricted alternate uses for a building, and high remodel costs. Additional undesirable characteristics include difficulties in accommodating user or equipment changes during design, documentation, pricing, implementation, use (such as less efficient work flow, increased worker stress, and the like), audit, or after-life. In the prior known project methods isolated events do occur which renders items relocatable that are normally inherently permanent. However, such isolated events are not part of a building system such that they change the nature of the facility use or afterlife. For example, isolated relocatable items will typically be demolished along with the rest of the building. However, where they are part of a project system of relocatable elements then the project becomes a candidate for de-construction and re-use rather than demolished and buried in a landfill.

Comform/Transform—For the purposes of this patent, to conform means to correspond in form or character; be similar; to act or be in accord or agreement; to comply; to act in accordance with current customs or modes; to bring into agreement or correspondence; to make similar; to change the nomenclature, semantics or documentation. To transform includes revising or substituting or to change markedly the appearance or form of something; or to change the nature, function, or condition of; to create or convert.

### FEATURES OF THE PRESENT INVENTION

Building Components and Architectural Elements—It is, therefore, a feature of the present invention to provide a project system and method that segregates or distinguishes between Building Components and Architectural Elements, where Building Components are necessary for the operation or maintenance of the building or are inherently permanent; and, Architectural Elements are removeable, reuseable, relocatable, or decorative, or provide some supplemental use.

Facility flexibility—A feature of the present invention is to provide a project system and method that enhances facility flexibility making reconfiguration of spaces to improve user efficiency more feasible.

Facility management—A feature of the present invention is to provide a project system and method that enhances facility management, in part because the facility is more flexible and documents are coordinated to relate to the various types of professionals involved.

Construction cost and time—Another feature of the present invention is to provide a project system and method that can reduce construction cost, time or complexity.

Interaction between the various trades—Another feature of the present invention is to provide a project system and method that reduces the required interaction and coordination between the various trades or subcontractors which can also reduce required involvement by a general contractor.

Remodeling construction/more rehabilitated projects/less demolition—Yet still another feature of the present invention is to provide a project system and method that simplifies remodeling construction which results in time and cost savings and predictability. This feature allows many projects to be rehabilitated that would otherwise be demolished.

Revisions during construction—Another feature of the present invention is to provide a project system and method that makes revisions during construction faster, simpler, more cost effective and cost predictable.

Reduces the employee down-time—Yet still another feature of the present invention is to provide a project system and method that reduces the employee down time associated with building remolding construction or maintenance.

Reduces the building down-time—Another feature of the present invention is to provide a project system and method that reduces the building down time because remodeling can be done more quickly (perhaps over weekend or overnight) with less demolition, noise, waste or delay.

Utilizes Architectural Elements—Another feature of the present invention is to provide a project system and method that utilizes Architectural Elements in the assembly of a building.

Increases efficiency of facility users—Yet still another feature of the present invention is to provide a project system and method that increases efficiency of facility users by enabling the facility to be easily reconfigured in the most efficient manner.

Increases efficiency of facility equipment—Yet still another feature of the present invention is to provide a project system and method that increases efficiency of facility equipment by enabling the equipment to be easily relocated to create a more efficient arrangement.

Electrical power—Another feature of the present invention is to provide a project system and method that provides Building Component electrical power on one hand, and Architectural Element electrical power on the other hand.

Lighting, plumbing, mechanical, millwork-cabinetry, ceilings, floors, walls, etc.—Yet another feature of the present invention is to provide a project system and method that provides Building Component lighting, plumbing, mechanical, millwork-cabinetry, ceilings, floors, walls, etc. on the one hand, and Architectural Element lighting, plumbing, mechanical, millwork-cabinetry, ceilings, floors, walls, etc. on the other hand.

Electrical power circuiting—Another feature of the present invention is to provide a project system and method that provides Architectural Element power and lights which have there own coordinated separate power circuits which allows for easier relocation. The Architectural Element power and lights will reduce or eliminate the required particular re-balancing of the electrical loads due to re-configuration as required in typical Building Component implementation.

Creation of Architectural Elements—Yet another feature of the present invention is to provide a project system and method for the creation, separation or identification of Architectural Elements during the pre-design, design, documentation, implementation, audit or after-life. This also accommodates future changes in environmentally sensitive or ecologically beneficial manners.

Distinguish documentation—It is another feature of the present invention to provide a project system and method to separate or distinguish documentation pursuant to those items in a building that are Building Components on one hand, and are Architectural Elements on the other hand.

Reduced need for licensed personnel—Another feature of the present invention is to provide a project system and method having Architectural Elements that reduces the instances where installation or relocation personnel have to be licensed or authorized.

Reduce need for many building permits—Another feature of the present invention is to provide a project system and method having Architectural Elements that reduce the instances where installation or relocation of Architectural Elements is required to obtain a building permit.

General Contractor—It is another feature of the present invention to provide a project system and method having Architectural Elements that may not necessarily require a general contractor thereby saving construction costs.

Reduce need for licensed design professionals—Yet another feature of the present invention is to provide a project system and method of constructing a building wherein the use of Architectural Elements often do not require the building owner to hire licensed professionals to design, redesign or implement their configurations or reconfigurations.

Less construction waste/conservation of energy—It is another feature of the present invention to convert items from Building Components to Architectural Elements so as to provide less waste in construction and to conserve energy.

Decorative items distinguished—Another feature of the present invention is to provide a project system and method that segregates or distinguishes between Building Component decorative items and Architectural Element decorative items while or by coordinating the decorative items with work or documents of architects, designers, engineers, contractors, facility managers, accountants, or manufacturers.

Supplemental task items distinguished—Another feature of the present invention is to provide a project system and method that segregates or distinguishes between Building Component supplemental task items and Architectural Element supplemental task items while or by coordinating the supplemental task items with work or documents of architects, designers, engineers, contractors, facility managers, accountants, or manufacturers.

Decorative items transformed—Another feature of the present invention is to provide a project system and method that transforms or conforms Building Component decorative items to Architectural Element decorative items while or by coordinating the decorative items with work or documents of architects, designers, engineers, contractors, facility managers, accountants, or manufacturers.

Supplemental task items transformed—Another feature of the present invention is to provide a project system and method that transforms or conforms Building Component supplemental task items to Architectural Element supplemental task items while or by coordinating the supplemental task items with work or documents of architects, designers, engineers, contractors, facility managers, accountants, or manufacturers.

Transforms items to Architectural Elements—Another feature of the present invention is to provide a project system and method that transforms Building Component items to Architectural Element items while or by coordinating the items with the work or documents of architects, designers, engineers, contractors, facility managers, accountants, or manufacturers, whereby transformation includes a physical change to the item.

Conforms items to Architectural Elements—Another feature of the present invention is to provide a project system and method that conforms Building Component items to Architectural Element items while or by coordinating the items with the work or documents of architects, designers, engineers, contractors, facility managers, accountants, or manufacturers, whereby to conform includes corrections to the descriptive documentation of the item.

Correctly characterize—Another feature of the present invention is to provide a project system and method that conforms the nomenclature or documentation associated with Building Components so as to correctly characterize them as Building Components or Architectural Elements.

Manufacturer's products—Yet still another feature of the present invention is to provide a project system and method to segregate or conform Building Components, on one hand; and segregate, create, transform, or conform Architectural Elements, on the other hand, with respect to the manufacturer's products, literature, designs, drawings and documents.

Segregate pre-design—Yet still another feature of the present invention is to provide a project system and method to segregate or conform Building Components, on one hand; and segregate, create, transform or conform Architectural Elements, on the other hand, with respect to the pre-design which includes site analysis, project Pro Forma, program, etc.

Segregate design—Yet still another feature of the present invention is to provide a project system and method to segregate or conform Building Components, on one hand; and segregate, create, transform or conform Architectural Elements, on the other hand with respect to the design which includes schematic design, design development, sketches, drawings, etc.

Segregate documentation—Yet still another feature of the present invention is to provide a project system and method to segregate or conform Building Components, on one hand; and segregate, create, transform or conform Architectural Elements, on the other hand with respect to the documentation which includes sketches, drawings, construction drawings, specifications, contracts, change orders, field orders, manufacture's literature, etc.

Segregate pricing—Yet still another feature of the present invention is to provide a project system and method to segregate or conform Building Components, on one hand; and segregate, create, transform or conform Architectural Elements, on the other hand with respect to the pricing which includes bidding and negotiation, etc.

Segregate implementation—Yet still another feature of the present invention is to provide a project system and method to segregate or conform Building Components, on one hand; and segregate, create, transform or conform Architectural Elements, on the other hand with respect to the implementation which includes construction administration, construction, installation, assembly, occupancy, place in service, use, user's manuals, etc.

Segregate audit—Yet still another feature of the present invention is to provide a project system and method to segregate or conform Building Components, on one hand; and segregate, create, transform or conform Architectural Elements, on the other hand with respect to the audit .

Segregate reconfiguration, relocation, removal, reuse or recycle—Yet still another feature of the present invention is to provide a project system and method to segregate or conform Building Components, on one hand, and segregate, create, transform or conform Architectural Elements, on the other hand with respect to reconfiguration, relocation, removal, reuse, or recycle.

Segregate retrofit or recycle into a new product—Yet still another feature of the present invention is to provide a project system and method to segregate or conform Building Components, on one hand; and segregate, create, transform or conform Architectural Elements, on the other hand with respect to the retrofit or recycle into a new product.

Segregate to create useable energy fuel—Yet still another feature of the present invention is to provide a project system and method to segregate or conform Building Components, on one hand; and segregate, create, transform or conform Architectural Elements, on the other hand with respect to creation of useable energy fuel.

Work of professionals coordinated to facilitate audit—Yet still another feature of the present invention is to provide a project system and method such that work or documents of facility owners, developers, financiers, architects, designers, accountants, contractors, facility managers, product manufacturers, and the like is coordinated so as to facilitate audit.

Conservation of natural resources by the work of professionals being coordinated with the laws—Yet still another feature of the present invention is to provide a project system and method such that work or documents of facility owners, developers, financiers, architects, designers, accountants, contractors, facility managers, product manufacturers, and the like is coordinated with the law. This also enhances the fulfillment of regulations enacted to encourage conservation of natural resources.

Additional features and advantages of the invention will be set forth in part in the description which follows, and in part will become apparent from the description, or may be learned by practice of the invention. The features and advantages of the invention may be realized by means of the combinations and steps particularly pointed out in the appended claims.

### SUMMARY OF THE INVENTION

A system for creating a project (including a building, facility or product) is disclosed. The system comprises two classifications of property, assets or items (1) a Building Component which is either inherently permanent or necessary for the operation or maintenance of the building, and (2) an Architectural Element which is either removeable, reuseable, relocatable, decorative, or supplemental.

Also, a method of creating a project (including a building, facility, or product) using Building Components and Architectural Elements is provided. The method of creating the project comprises the steps of determining the scope of the project such that the project can be defined, and determining if the project is a candidate for Architectural Element coordination. If the project is not a candidate for Architectural Elements coordination, then the Building Components are identified and implemented for the construction of the project. If the project is a candidate for Architectural Elements coordination, then determining if the design is Architectural Element coordinated. If the design is not Architectural Element coordinated, then coordinating the design with the Architectural Elements. If the design is Architectural Element coordinated, then identify the Architectural Elements for the scope of the defined project, identify the Building Components for the scope of the defined project, and implement the identified Architectural Elements and Building Components for creating the project.

Further, a method of classifying property or assets associated with a project (including a building, facility, or product) using building components and architectural elements is provided. The assets have tangible and intangible characteristics. The method of classifying assets comprising the steps of determining if the asset is inherently permanent, determining if the asset is relocatable, determining if the asset is necessary, determining if the asset is decorative, determining if the asset is supplemental, conducting a factual analysis of the tangible and intangible characteristics of the asset for verifying the classification of the property or asset.

Still further, a system for creating a project (including a building, facility, or product), the project having a plurality of building components which are either inherently permanent or necessary for the operation or maintenance of the project is provided. The improvement being a plurality of architectural elements which are either removeable, reuseable, relocatable, decorative, or supplemental such that the architectural elements can be reconfigured for improving user efficiency, enhancing facility management, reducing construction cost and time, simplifying remodeling construction thereby allowing projects to be rehabilitated that would otherwise be demolished, reducing the employee down time associated with building remodeling construction and maintenance, reducing the building down time because remodeling can be done more quickly with less demolition, noise, waste or delay, providing for the easy relocation of equipment or personnel, providing for individualized power circuits which allows for easier relocation of power and lights for reducing the required particular re-balancing of electrical loads, and at least one of separating and identifying the Architectural Elements during the pre-design, design, documentation, implementation, audit or after-life to accommodate future changes in environmentally sensitive or ecologically beneficial manners.

### BRIEF DESCRIPTION OF THE DRAWINGS

The accompanying drawings which are incorporated in and constitute a part of the instant specification, illustrate various preferred embodiments of the invention and together with the general description of the invention given above and the detailed description of the preferred embodiments given below, serve to explain the principles of the invention. These drawings represent examples of the many acceptable embodiments of the present invention.

FIG. 1 is a flow chart illustrating the basic constituents of the project system and method of the present invention in association with the prior known building constituents.

FIG. 2 illustrates the project system and method of the present invention with the project and examples of Building Components in comparison with examples of Architectural Elements.

FIG. 3 is a flow diagram illustrating another embodiment of the project system and method of the present invention.

FIG. 4 is a floor plan of a prior art building comprising Building Components.

FIG. 5 illustrates a comparable floor plan as that illustrated in FIG. 4 which incorporates differing utility Architectural Elements of the present invention.

FIG. 6 illustrates an elevation view of a building that also comprises Architectural Elements of the present invention.

FIG. 7 illustrates a floor plan for the second floor of the facility elevated in FIG. 6.

FIG. 8 illustrates a fixed-structure sink comprising Building Components as taught by the prior art.

FIG. 9 illustrates a relocatable sink element comprising Architectural Elements as used in practicing the project system and method of the present invention.

FIG. 10 illustrates yet another embodiment of the project system and method of the present invention concerning distinguishing Building Component documentation and Architectural Element documentation.

FIG. 11 illustrates the prior art methodology of using Building Components in the construction or manufacture of a building project in contrast with the use of Architectural Elements as practiced with the project system and method of the present invention.

FIG. 12 is an illustration of yet another embodiment of the facility or building system and method of the present invention wherein the project is illustrated from the initiation of the project through the implementation phase showing that the Architectural Elements can be coordinated at any phase.

FIG. 13A illustrates the phases of a conventional project utilizing Building Components from origin through the implementation phase, the project abandonment phase, the demolition phase and the low-grade fuel waste phase or landfill-health hazard.

FIG. 13B illustrates the phases of a novel project utilizing the Architectural Elements of the present invention from origin through the implementation phase, the project audit phase, the reconfigure-relocate-remove-reuse phase, the retrofit-recycle-new product phase and the energy fuel phase.

FIG. 13C is an illustration of yet another embodiment of the project system and method of the present invention wherein the project is illustrated from the initiation of the project through the afterlife phase showing that the Architectural Elements can be coordinated at any phase with respect to Building Components. It will be appreciated by those skilled in the art that there are times when the phases can be in reverse order or alternating order.

FIG. 14 is an illustration of yet another embodiment of the project system and method of the present invention wherein an existing project is evaluated with respect to being coordinated for Architectural Elements after implementation, construction and re-construction.

FIG. 15 illustrates yet another embodiment of the project system and method of the present invention concerning determining classification of project assets, items, or things as Building Component documentation and Architectural Element documentation.

The above general description and the following detailed description are merely illustrative of the generic invention, and additional modes, advantages, and particulars of this invention will be readily suggested to those skilled in the art without departing from the spirit and scope of the invention.

### DETAILED DESCRIPTION OF THE PREFERRED EMBODIMENTS

Reference will now be made in detail to the present preferred embodiments of the invention as described in the accompanying drawings.

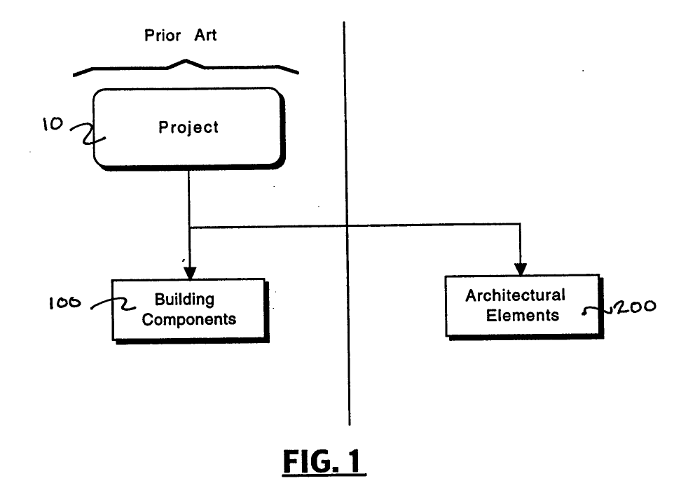

FIG. 1 is a flow chart illustrating the basic parts or phases of the present invention. The project 10 is typically associated with an assemblage of Building Components 100. The project may be a building, facility, or a manufacturer's product, etc. The combination of the project 10 and Building Components 100 is what is typically known in the art. The present invention includes the new usage of Architectural Elements 200. Architectural elements 200 may be similar to or provide the same utility as Building Components, but will have the characteristics of being removable, reusable or decorative, or provide some supplemental characteristic. The Building Components 100 are necessary for the operation or maintenance of the building or they are inherently permanent; whereas the Architectural Elements 200 are removable, reusable, or “relocatable,” provide support for some supplementary task, or are merely decorative.

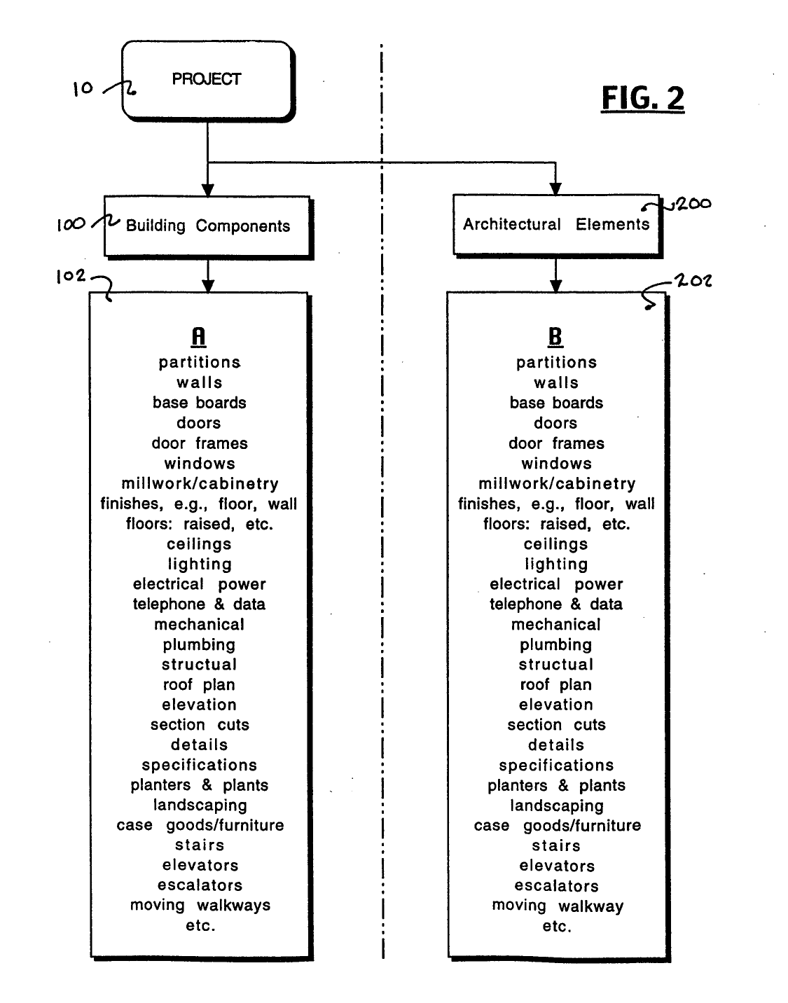

FIG. 2 illustrates the present invention with the project 10 and Building Components 100 in comparison with the Architectural Elements 200. The Building Components 100 may be categorized as the listing A 102. The list A 102 includes without limitation partitions, walls, baseboards, doors, door frames, windows, mill work and cabinetry, finishes (for example: floor, wall, overhead, etc.), floors (for example: raised, lowered, pavers, paving, etc.), ceilings, lighting, electrical power, telephone and data means, mechanical, plumbing, structural, roof, roof plan, elevation, balconies, fences, screens, section cuts, details, specifications, landscaping, planters and plants, case goods and furniture, stairs, elevators, escalators, moving walkways, and the like. The characteristics of all the Building Components 102 listed in list A 102 are that they are necessary for the operation or maintenance of the building or they are inherently permanent. The Architectural Elements 200 can be described as items in list B 202. List B 202 provides for removable, reusable, or supplemental, or decorative partitions, walls, baseboards, doors, door frames, windows, mill work and cabinetry, finishes (for example, floor wall overhead, etc.), floors (for example, raised, lowered, pavers, paving, etc.), ceilings, lighting, electrical power, telephone and data means, mechanical, plumbing, structural, roof, roof plan, elevation, balconies, fences, screens, section cuts, details, specifications, landscaping, planters and plants, case goods and furniture, stairs, elevators, escalators, moving walkways, and the like. Thus, many characteristics of Building Components can be similar to those of Architectural Elements, however, the components would be very different, for example, a Building Component wall would be inherently permanent and not an easily removable and reusable wall. Whereas, an Architectural Element wall would be a wall that would be readily movable so as to provide for enhanced project uses, and preservation of the environment by reusing elements or products as well as by separation of project waste which can reduce or prevent health hazards caused by off-gases in landfills, and by creating useful energy from even the reduced amount of project waste, etc.

It can be appreciated by those skilled in the art that the term wall includes any partition or wall and any related apparatus comprising the wall including things in or things on the wall, for example doors, door hardware, door frames, windows, baseboards, base tracks, crown trim, headtracks, studs and fastners, floating compounds, joint tape, adhesives, wall boards and panels, and the like.

It can also be appreciated by those skilled in the art that the term lighting includes a light and any related apparatus comprising wiring, conduit, switches, panel boxes, circuit boxes, junction boxes, connectors, and the like. It can also be appreciated by those skilled in the art that the term electrical apparatus comprising wiring, conduit, switches, panel boxes, circuit boxes, junction boxes, connectors, solar panels, and the like for electrical power, voice, data, telephone, and the like.

It can also be appreciated by those skilled in the art that the term plumbing apparatus comprising pipes, tubes, conduit, connectors, valves, solvents, tubs, sinks, toilets, facuet, showers, meters, and the like for water, gas, air, and the like.

It can also be appreciated by those skilled in the art that the term mechanical apparatus comprising ducts, furnances, compressors, blowers, filters, registers, grills, pipes, tubes, conduit, connectors, valves, solvents, facuet, meters, thermostats, heat collectors, solar collectors, solar panels, and the like for effecting room temperture, humidity, air flow, and the like.

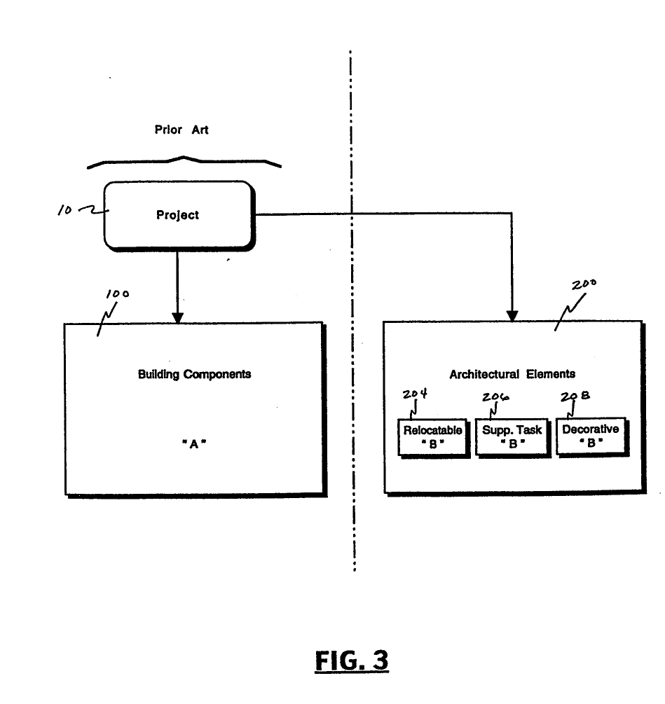

FIG. 3 is a flow diagram illustrating another embodiment of the present invention. FIG. 3 illustrates the project 10 in association with the Building Components A 100. The Architectural Elements 200 are also part of the project 10, but have not been considered or identified as they are with respect to the present invention. Particularly, the Architectural Elements 200 comprise elements which are relocatable 204, provide supplementary tasks 206, or are decorative 208. Generally, the Building Components 100 do not have the inherent, removable, relocatable, or reusable characteristics required by the Architectural Elements 200.

FIGS. 4, 5, 6, 7, 8 and 9 are examples to help materially illustrate an understanding of Building Components and Architectural Elements.

FIG. 4 is a floor plan of a prior art project comprising Building Components 100. Particularly, FIG. 4 illustrates a building floor plan 300. The building floor plan 300 has exterior building walls 302, interior building walls 304, and building lighting 310. All of the Building Components illustrated in FIG. 4 are necessary for the operation or maintenance of the building, or they are inherently permanent. The architect, designer, engineer, facility manager, developer, project professional, product manufacturer, or contractor is generally unaware of the full significance of whether or not the items are necessary for the maintenance or operation of the project and therefore make no such distinction, nor effort to transform Building Components into Architectural Elements; conversely, select accountants and attorneys may be partially aware of the significance but lack the technology, or method to coordinate with the project, process, or system.

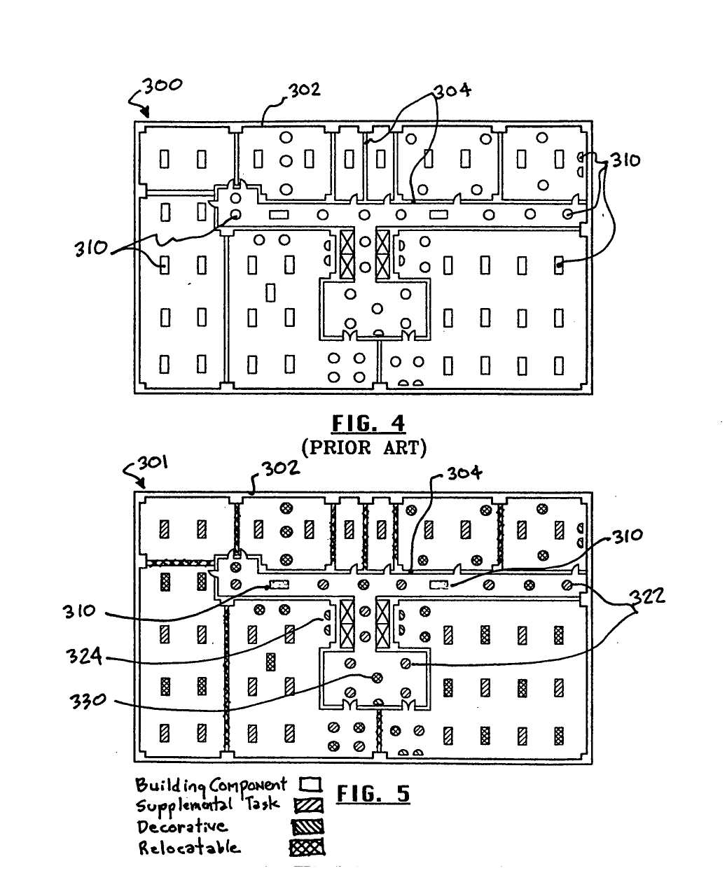

FIG. 5 illustrates a comparable floor plan as that illustrated in FIG. 4 which incorporates the differing utility elements of the present invention. It should be noted that the project floor plan 301 in FIG. 5 also has exterior building walls 302, interior building walls 304 and building lighting 310. Additionally, the floor plan 301 has supplemental task lighting 322 and decorative lighting 324. The supplemental task lighting 322 is supplemental (not necessary) to the operation or maintenance of the building, and the decorative lighting 324 is merely decorative. Items may or may not also be relocatable, removable or reusable 330 as in this particular example; however, it is also common to distinguish these elements where appropriate.

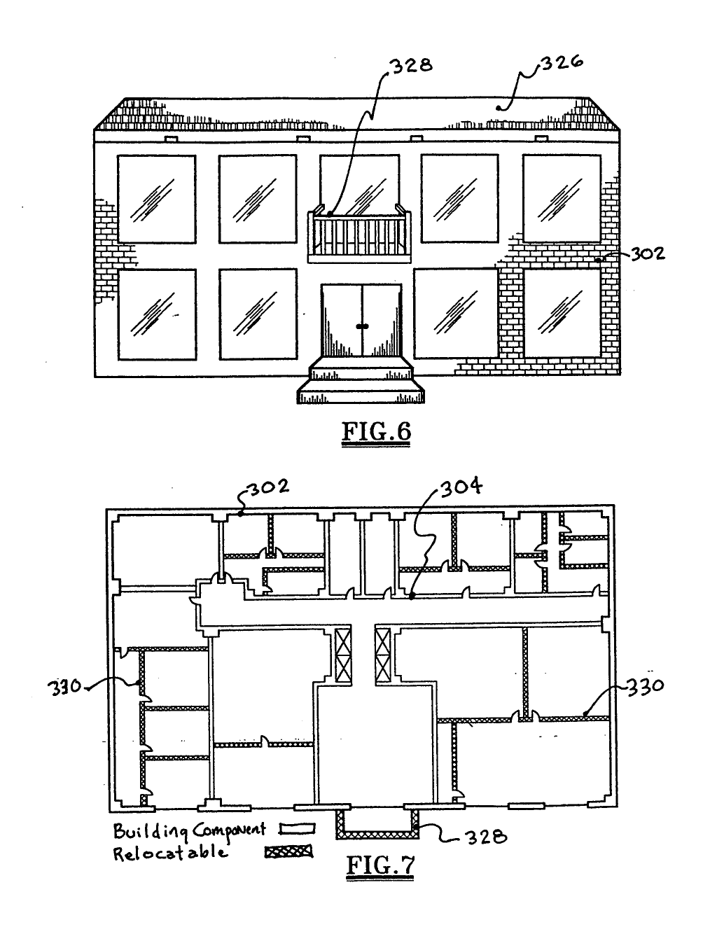

FIG. 6 illustrates an elevation view of a project comprising elements of the present invention. The project illustrated in FIG. 6 has exterior building walls 302 which are Building Components 100 as illustrated in FIGS. 1-3. Also, FIG. 6 has a decorative mansard roof looking screen 326 which can be removed, reused or changed to have a different view or eye appeal. Similarly, a decorative balcony 324 is provided. The balcony 324 can be moved from one location to another and provides for various uses or reuses in conjunction with other similar relocatable, removable, reusable balconies. Many other Building Components could be transformed or conformed into Architectural Elements such as decorative skins, moveable doors or windows or partitions or roof panels or paving, etc.

FIG. 7 illustrates a floor plan for the second floor of the project elements elevation in FIG. 6. The floor plan in FIG. 7 illustrates exterior building walls 302, interior building walls 304 and associated windows and doors. Of particular interest in FIG. 7 is the use of the relocatable walls 330 and associated doors, windows, power, etc. The relocatable walls 330 are provided so that in areas of the project where they are used the interior can be changed with need. The relocatable walls 330 are not part of the Building Components 100.

FIG. 8 illustrates a fixed-structure sink 340 as taught by the prior art. The fixed-structure sink 340 comprises building walls 342, a building fixture 344 and building plumbing 346. All of the components of the fixed structure sink 340 are rigidly secured, inherently permanent, and are not easily removable or reusable.

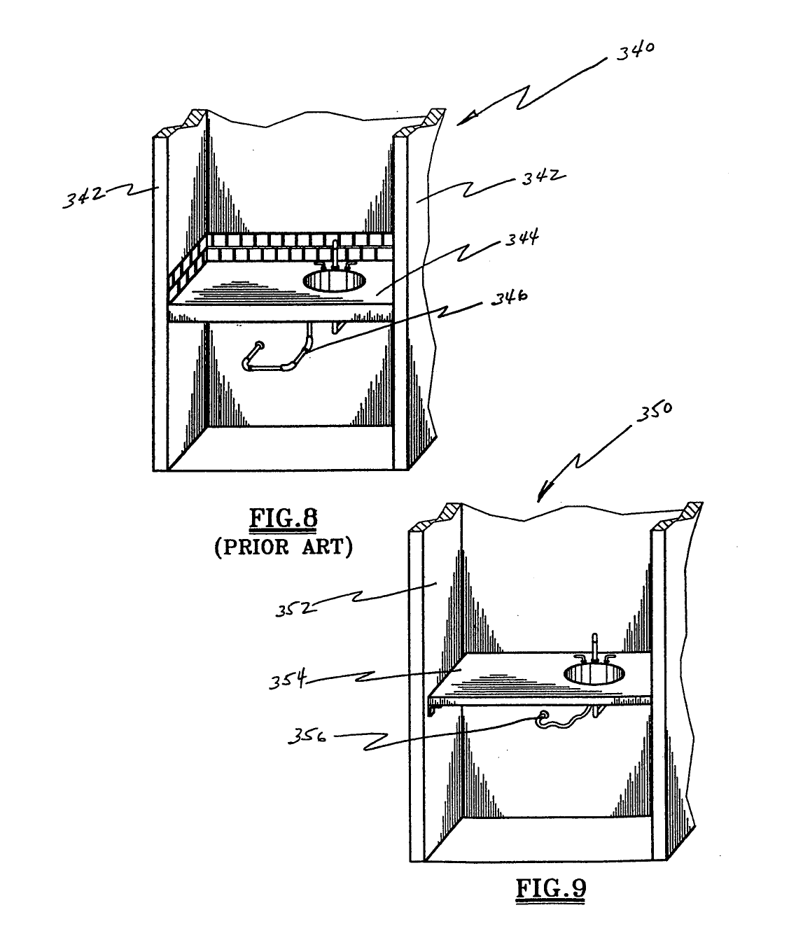

FIG. 9 illustrates a relocatable sink structure 350 as would be used in practicing the present invention. The relocateable sink structure 350 comprises a relocatable wall 352, a relocatable fixture 354 and relocatable plumbing 356. All of the elements of the relocatable sink 350 can be disassembled, moved and implemented or used with other relocatable Architectural Elements 200. Simply stated, any relocatable Architectural Element 200 can be used in association with or in conjunction with some Architectural Element 200 or some other Building Component 100.

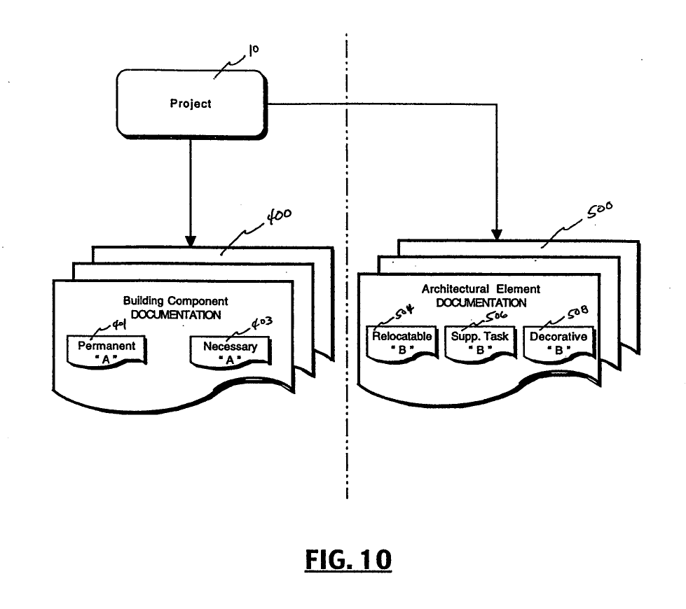

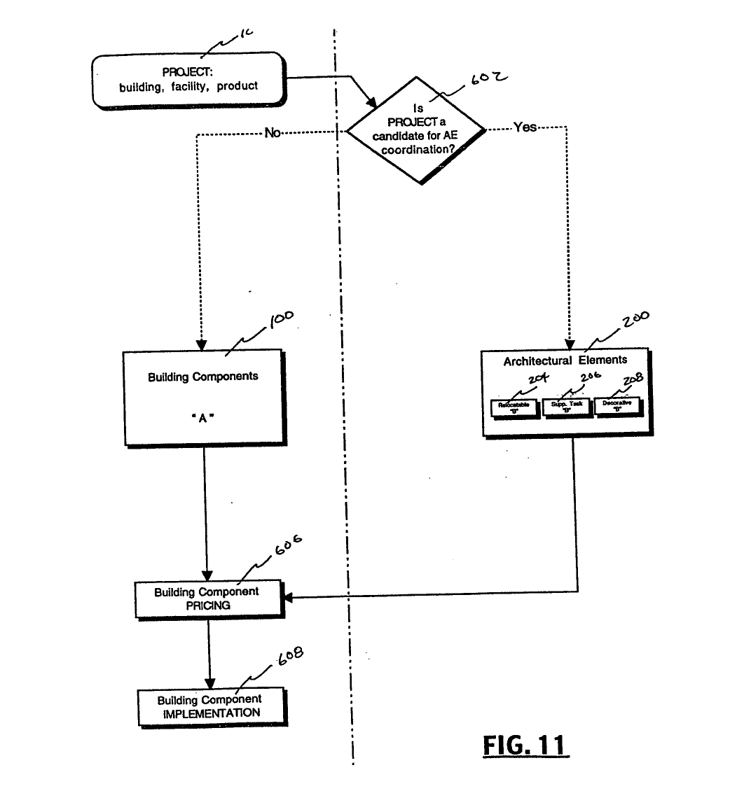

FIG. 10 illustrates yet another embodiment of the present invention concerning distinguishing Building Components 100 and Architectural Elements 200. Particularly in FIG. 10, the Building Components 100 are described in the Building Component documentation 400 and the Architectural Element documentation 500. The documents associated with the various types of Building Components 400 are provided. Particularly, documents related to the Building Components 400 are inherently permanent 401 or necessary for the operation or maintenance of the building 403. The documents associated with the various types of Architectural Elements 500 are also provided. Particularly, documents related to the Architectural Elements 500 are the removable, reusable, or “relocatable” Architectural Element documents 504, the supplemental task documents 506, and the decorative Architectural Element documents 508. The Architectural Element documents 500 are provided within the scope of all documentation for the Architectural Elements 500.

It is important to distinguish between the Building Component documentation 400 and the Architectural Element documentation 500. Project items, assets or things are often distinguished by or separated into documents, diagrams or drawings as illustrated in FIG. 10. The organization of such items typically provides for the separation into titles that are descriptive of the architectural purpose for which they are used. For example, a partition plan may describe or include walls, doors, door frames or windows. The partition plan may also describe mill work and cabinetry. Or, if the scope of the mill-work is large enough, the partition plan may also provide for a separate drawing for the mill-work often called a mill-work plan. Likewise, various documents may also describe electrical power, telephone lines, data lines, finishes, lighting, plumbing, structural or the like. If the scope of the project is large enough these items may be described in separate documents or drawings, or may be provided in composite drawings. Further, the partition plan may be titled floor plan, construction plan or the like. Examples of typical groupings of project items, assets or things would be a partition plan, a floor plan, a finishes plan, an electrical plan, a telephone plan, a data plan, a security plan, a reflective ceiling plan, a lighting plan, a lighting power plan, a furnishing plan, a plumbing plan, a plumbing riser diagram and the like. Such project items are typically grouped and can be categorized under terms that are somewhat descriptive of the use of the item.

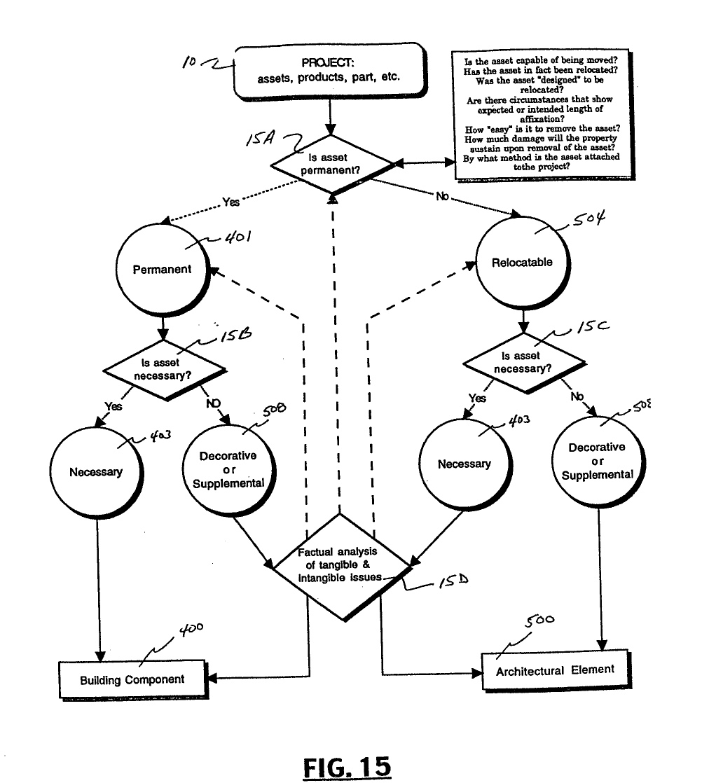

Typically, the building lighting used as a Building Component 100 is placed so as to illuminate work areas. The building lighting is often placed in a uniform pattern to meet general requirements. For example the Lights are often placed to meet the general needs at all locations in the building. Thus, Building Component lighting is typically considered necessary for the operation or maintenance of the building or it is often inherently permanent. Such Building Component 100 lighting typically requires more energy wattage use for the project as a whole because the foot-candle requirements must be sufficiently high at any given location to provide for detail work, not just at specialty locations with high foot-candle requirements. However, when Building Component lighting is used in coordination with Architectural Element lighting then the requirements for overall Building Component lighting can be significantly reduced. This can result in substantial energy savings plus reduced glare and worker fatigue. Therefore, energy requirements for Building Component 100 lighting are typically higher, or lower, than the requirements set for the Architectural Elements 200. The Architectural Elements 200 could be used, and are used, for particular matters when used as a supplemental task element 206. Architectural Elements are often designed with the “intent” to be moved as the associated desks or work task is moved. Transforming or conforming of Building Component lighting to Architectural Element lighting encourages easy relocation of lights for optimum efficiency which reduces environmental depletion of natural resources for energy use while reducing glare and health hazards associated with the eye strain and headaches associated with the glare. Refer to FIG. 15 for a detailed understanding of Building Components versus Architectural Elements.

FIG. 11 illustrates the prior art methodology of using Building Components 100 in the construction or manufacture of a project 10 in contrast with the use of Architectural Elements 200 as practiced with the project system and method of the present invention. The prior art method would be to design a project 10, assemble the Building Components 100, perform the bidding and pricing 606, and implement the construction or the manufacture of the project 608. The present invention requires a different analysis than the prior art analysis. In the present invention, the project 10 is determined. Thereafter, a decision 602 is made with respect to whether the project 10 is a candidate for coordination of the Architectural Elements 200. If yes then, the project 10 is designed with Architectural Element 200 coordination. Those things that are not candidates for Architectural Elements 200 coordination would be typical Building Components 100. Those items that are candidates for Architectural Elements 200 coordination would be designed as Architectural Elements 200. The coordination of the design may include removable, reusable, or “relocatable” Architectural Elements 204, supplemental task Architectural Elements 206, or decorative Architectural Elements 208. All of the design work would result in various Architectural Elements 200. The Architectural Elements 200 may be in the form of relocatable 204, supplemental task 206, decorative 208 or some other descriptive term that would be appreciated by those skilled in the art. The Architectural Elements 200 would then be priced 606 (however in many situations it would be best for them to be priced separately and distinctly from the Building Components 100 because the Architectural Elements 200 are very different items). The combination of the Building Components 100 and the Architectural Elements 200 would result in the overall implementation 608 and result in construction and manufacture of the project.

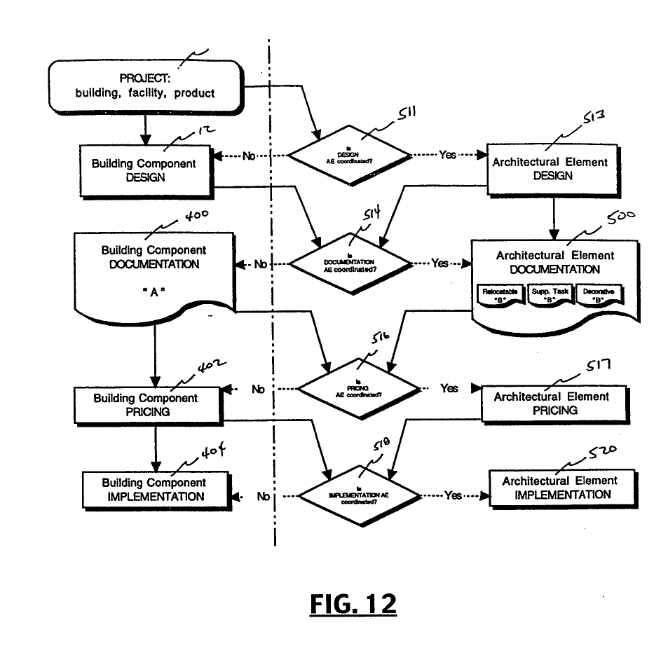

FIG. 12 is an illustration of yet another embodiment of the project system and method of the present invention wherein the project 10 is illustrated from the initiation of the project 10 through the implementation phase 404 showing that the Architectural Elements can be coordinated at any phase. Typically, a project 10 may be comprised of a building, a facility, or some other product. The Building Component design 12 is performed. Then typically the Building Component documentation 400 of the Building Component design is performed. The Building Component documentation 400 can include, for example, components such as partitions, walls, baseboards, doors, windows, stairs, elevators, and the like 102. From the Building Component documentation 400, the Building Component pricing 402 is derived. The Building Component documentation 400 provides the resources and information to price each specific Building Component. Thus, the Building Component pricing 402 is capable of formulation based upon the Building Component documentation 400. With the Building Component documentation 400, the Building Component implementation 404 can be accomplished. Building Component implementation 404 would include purchasing the Building Components pursuant to the Building Component pricing 402 and construction, manufacturing or implementing 404 the building pursuant to the Building Component documentation 400.

The process of defining a project 10, achieving a Building Component design 12, creating the Building Component documentation 400, performing the Building Components pricing 402 and implementing the construction 404 of the Building Components 100, provides for the typical implementation process of a project. One aspect of the present invention provides that the design is coordinated with various Architectural Elements 200 which are not necessary for the operation or maintenance of the building. For example, as illustrated in FIG. 12, the project 10 can be defined. Thereafter, the Building Component design 12 is implemented, and, a determination is made whether the design is to be Architectural Element coordinated 511. If it is not going to be coordinated with an Architectural Element design the Building Component design 12 is all that is necessary. If the project (or part of the project) design is going to be coordinated with the Architectural Elements 200, an Architectural Element design 513 must be performed. With the Architectural Element design 513 created, the Architectural Element documentation 500 can be created. It is anticipated with the present invention that the Architectural Element documentation 500 comprises relocateable 504, supplemental task 506 or decorative 508 documents. The various documents 500 associated with relocateable 504, supplemental task 506 or decorative 508 Architectural Elements are coordinated so as to implement the project design 10 in a manner to achieve features such as health, safety, and welfare of the public, conservation of time and expenses, facility flexibility, environmental conservation or preservation of natural resources, and or energy related conservation and benefits, and the like.

After the Architectural Element documentation 500 is provided, the determination is made as to whether all, part, or none of the pricing 402 will be Architectural Element coordinated 516. If all or part of the pricing is not going to be coordinated with Architectural Elements 200, the Building Component pricing 402 is performed. If all or part of the pricing is going to be coordinated with the Architectural Elements 200, the Architectural Element pricing 517 is initiated. After the Architectural Element pricing 517 is provided, a determination 518 must be made as to whether the implementation of all or part of the project will be coordinated with the Architectural Element documentation 500. If the implementation of the project is not going to be coordinated with Architectural Elements 200, the Building Component implementation 404 can readily be pursued. If the project implementation is to be coordinated with the Architectural Elements 200, then the Architectural Element implementation 520 will be pursued. Thereafter, the Architectural Element implementation 520 and the Building Component implementation 404 will be combined for final implementation of the project 10. It can be appreciated that at any time during the normal path after the project conception 10 to the Building Component implementation 404, the project can be coordinated with the Architectural Elements 200. For example, after the Building Component design 12 is performed, a determination can be made with respect to whether all, part, or none of the documentation will be coordinated 514 with Architectural Elements 200. If the documentation will not be coordinated 514 with Architectural Elements 200, the Building Component documentation 400 will be produced and, if the documentation will be coordinated 514 with Architectural Elements 200, the Architectural Element documentation 500 is produced as well. Similarly, at the step of Building Component pricing 402, a determination 518 can be made as to whether the implementation will be coordinated with Architectural Elements 200. If no coordination, then the Building Component implementation 404 is used, if there will be coordination, the Architectural Element implementation 520 is used, and thereafter, implemented with the Building Component implementation 404. Thus, at any step during a project 10, the coordination with Architectural Elements 200 can be considered.

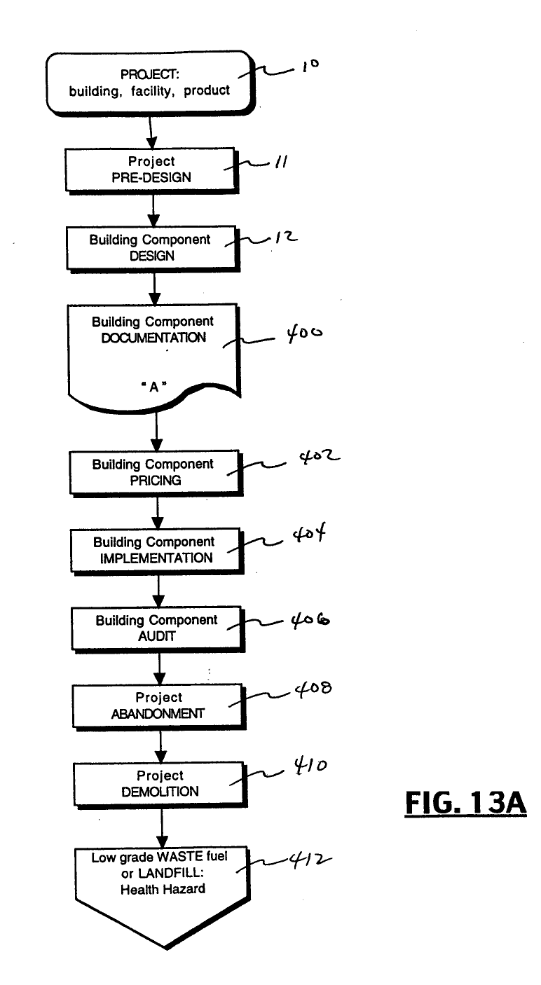

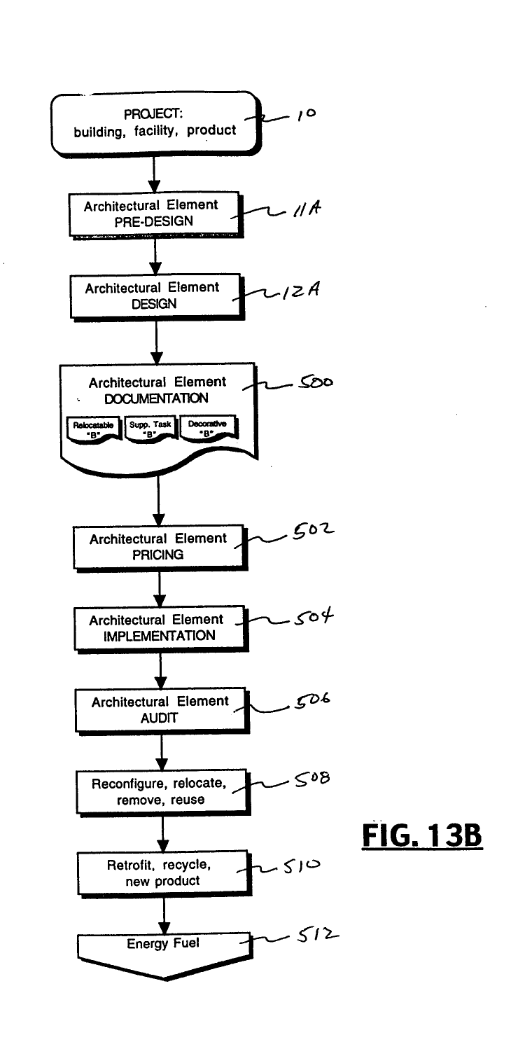

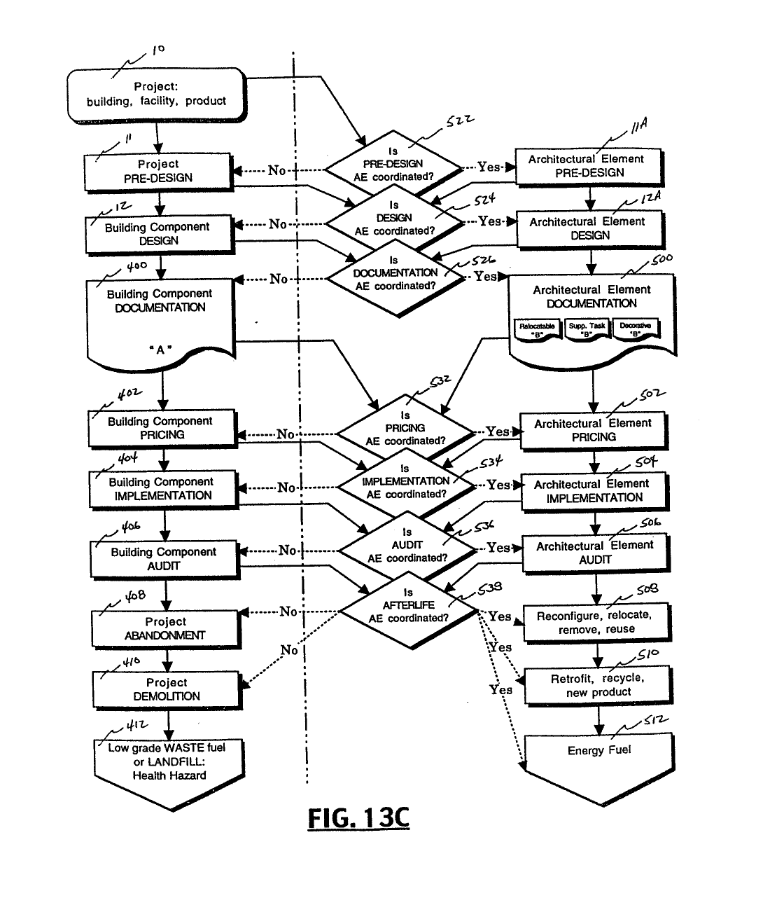

FIG. 13A illustrates the phases of a conventional project utilizing Building Components 100 from origin through the implementation phase 404, the project audit 406, the project abandonment phase 408, the demolition phase 410 and the low-grade fuel waste or landfill health hazard phase 412. FIG. 13A illustrates the project 10 being, for example, a building, facility or product. After the project 10 is identified, the project pre-design phase 11 is done. It is typical in the art to have a pre-design phase 11 for the project 10 prior to a design phase 12. After the project pre-design phase 11, the Building Component design 12 is done which normally includes schematic design and design development. The Building Component design phase 12 provides for all of the Building Components 100 to be designed as normally done in a building, i.e., as fixed assets within the building. After the Building Component design phase 12, the Building Component documentation phase 400 is done which includes specifications, drawings, etc. The Building Component documentation phase 400 provides for the production of documents for all the Building Components 100 designed in the Building Component design phase 12. After the Building Component documentation phase 400, the Building Component pricing phase 402 is done. The Building Component pricing phase 402 provides for the bidding and pricing of all the Building Components 100. Thereafter, the Building Component implementation phase 404 is done. The Building Component implementation phase 404 provides that the building is constructed, placed in service, occupied, etc. Sometime during the project 10, normally (but not limited to) after the building component implementation phase 404, the Building Component audit phase 406 is done. The Building Component audit phase 406 provides that each of the Building Components 100 is itemized and appropriately audited using generally accepted accounting principals. Thereafter, the project abandonment phase 408 is typically initiated. After a project 10 has lived its useful life, the project abandonment phase 408 is implemented. The project abandonment phase 408 provides for the de-utilization of the project 10. After the project abandonment phase 408, the project is typically demolished 410. The project demolition phase 410 provides that the project is reduced to waste material. Thus, the low grade waste fuel or landfill health hazard phase 412 is the result of the project demolition phase 410. Refer to the “features” section for undesirable characteristics associated with the methods depicted by FIG. 13A.

FIG. 13B illustrates the phases of a novel project utilizing the Architectural Elements 200 of the present invention from origin through the implementation phase 504, the project audit phase 506, the reconfigure-relocate, remove, or reuse phase 508, the retrofit, or recycle to, or new product phase 510 and the energy fuel phase 512. FIG. 13B provides for a unique way to design portions of a project. FIG. 13B provides the steps associated with incorporating Architectural Elements 200 into a project 10. It can be appreciated that the steps of implementing the Architectural Elements 200 into a project 10 can be in various arrangements and that the order identified in FIG. 13B is a preferred order, but not a required order. As the project 10 is conceptualized, the Architectural Element pre-design phase 11A is implemented. The next phase is the Architectural Element design phase 12A. This includes schematic design, design development, etc. The Architectural Element design phase 12A provides for the design of the Architectural Elements 200 as appropriate for the particular project 10. After the Architectural Element design phase 12A, the Architectural Element documentation phase 500 is done. The Architectural Element documentation phase 500 provides for the creation of documents associated with removable, reusable, or “relocateable” Architectural Elements, supplemental task Architectural Elements, and decorative Architectural Elements. This includes specifications, drawings, contracts, etc. After the Architectural Element documentation phase 500, the Architectural Element pricing phase 502 is performed. The Architectural Element pricing phase 502 includes the biding and pricing of the Architectural Elements 200. After the pricing 502, the Architectural Element implementation phase 504 is done. The Architectural Element implementation phase 504 provides that the project is constructed, installed, or assembled, and includes occupancy, use, placed-in-service, etc. After implementation, it is typical to have an Architectural Element audit phase 506 which provides that the specific Architectural Elements 200 are placed in their appropriate categories, for example, a relocateable Architectural Element, a supplemental task Architectural Element, or a decorative Architectural Element. Thereafter, it is available in practicing the present invention that the reconfigure, relocate, remove or reuse phase 508 is implemented. This phase 508 provides that the project can be totally or partially reconfigured, relocated, removed or reused. It can be appreciated by those skilled in the art that such an undertaking is complicated if not impossible with the implementation of typical Building Components 100. Also, after the Architectural Element implementation phase 504, the project 10 can be altered by the retrofit, or recycle to, or new product phase 510. The retrofit, or recycle to, or a new product phase 510 provides that the existing project 10 can be changed totally or partially. After the useful life of the project 10, the Architectural Elements 200 provide an energy fuel phase 512. The energy fuel phase 512 provides that the waste product from the project 10 have adequate end uses.

FIG. 13C is an illustration of yet another embodiment of the project system and method of the present invention wherein the project 10 is illustrated from the initiation of the project through the afterlife phase 538 showing that the Architectural Elements 200 can be coordinated at any phase with respect to Building Components 100. FIG. 13C is a composite of FIG. 13A and FIG. 13B incorporating the Building Component aspect of a project 10 with the Architectural Element aspects of the project 10. Also, FIG. 13C provides the related decision-making associated with incorporating the present invention at any location along the life of a project. The project 10 is determined to be a building, facility or product. Typically, after the project 10 is established, the project pre-design phase 11 can be done or the decision phase 522 for coordinating the pre-designed with Architectural Elements is addressed. If it is determined that the pre-design is not going to be coordinated with the Architectural Elements, then the project pre-design phase 11 is performed. If it is determined that all or part of the pre-design is to be coordinated with Architectural Elements, then the Architectural Element pre-design phase 11A is done on appropriate parts. Typically, the next decision phase 524 is to determine if all or part of the design is to be coordinated with Architectural Elements is addressed, and if all or part of the design is coordinated with the Architectural Elements, then the Architectural Element design phase 12A is done on appropriate parts. If the Architectural Elements are not to be coordinated with the design, then the Building Component design phase 12 is to be done. Typically, the next decision phase 526 is whether or not to coordinate the documentation with the Architectural Elements. If the documentation is to be coordinated with all or part of the Architectural Elements, the Architectural Element documentation phase 500 is done on the appropriate parts. If the documentation is not to be coordinated with Architectural Elements then the Building Component documentation phase 400 is to be done. The Building Component documentation phase 400 provides for the documentation supporting those components that are required and necessary for the operation or maintenance of the building or are inherently permanent. The Architectural Element documentation phase 500 provides for the documentation of items that are relocatable, supplemental task or decorative. Typically, the next decision phase 532 is whether the pricing is to be coordinated with the Architectural Elements. If all or part of the pricing is coordinated with the Architectural Elements, the Architectural Element pricing phase 502 is done on the appropriate parts. If the pricing is not to be coordinated with the Architectural Elements, the Building Component pricing 402 is to be done. Typically the next decision phase 534 is whether the implementation is to be coordinated with the Architectural Elements. If all or part of the implementation is to be coordinated with the Architectural Elements, the Architectural Element implementation phase 504 is carried out on the appropriate parts. If the implementation is not to be coordinated with the Architectural Elements, the building component implementation phase 404 is carried out. Typically, the next decision phase 536 is whether an audit is to be coordinated with Architectural Elements. If an audit is to be coordinated with all or part of the Architectural Elements, an Architectural Element audit phase is initiated on the appropriate parts. If an audit is not to be coordinated with the Architectural Elements, a Building Component audit phase 406 is typically implemented. Typically, the next decision phase 538 is whether the afterlife of the project is to be coordinated with Architectural Elements. If all or part of the afterlife is coordinated with the Architectural Elements there are several options that are appropriate for the coordinated parts. The project can be in the reconfigure, relocate, remove, or reuse phase 508, the retrofit, or recycle to, or new product phase 510 or the energy fuel phase 512. It can also be appreciated that if the afterlife 538 is coordinated with Architectural Elements then the reconfigure, relocate, remove or reuse phase 508 can proceed into the retrofit, or recycle to, or new product phase 510 which can proceed into the energy fuel phase 512. Similarly, if the afterlife of the project 10 is not to be coordinated with the Architectural Elements two alternate possibilities exist. The project abandonment phase 408 can be implemented or the project demolition phase 410 can be implemented. It can also be appreciated that if the project abandonment phase 408 is done, then the project demolition phase 410 could be performed thereafter. The last phase would be the low grade waste fuel or landfill health hazard phase 412. Refer to the “features” section or similar figures for benefits associated with this new project system and methods.

Thus, FIG. 13C shows that the interaction of the Architectural Elements 200 with the Building Components 100 can be implemented at numerous decision phases. Particularly the decision phases are the coordination of Architectural Elements with the pre-designed phase 522, the coordination of the design with the Architectural Elements phase 524, the coordination of documentation with Architectural Element phase 526, the coordination of pricing with the Architectural Elements phase 532, the coordination of implementation with Architectural Element phase 534, the coordination of audit with Architectural Element phase 536, and the decision phase of whether to coordinate Architectural Elements with the afterlife 538. These decision phases can be taken in the order illustrated in FIG. 13C, or in any other relevant order.

The decision of coordinating Architectural Elements 200 can be initiated at various stages of a project 10 as illustrated in FIG. 13C. The decision can be made up-front after the project 10 is defined by coordinating the design with Architectural Elements 524. The decision to coordinate the documentation with Architectural Elements 526 can be made after the step of Building Component design 12. Also, the decision to coordinate pricing with Architectural Elements 532 can be initiated after the Building Component documentation 400 has been performed. Still further, the coordination of the implementation with Architectural Elements 534 can be initiated after the Building Component pricing phase 402 or the Architectural Element pricing phase 502. Still further, the determination of whether the after life of the Architectural Elements will be coordinated 538 can be determined after the Building Component implementation 404 and after the Architectural Element implementation 504. Once it is determined that the Architectural Elements 200 will not be coordinated with the after life 538, the project abandonment 408 can be performed or the project demolition 410 can be performed. In either case, low grade waste fuel or landfill health hazard 412 will typically be created. On the other hand, if the after-life is coordinated 538 with the Architectural Elements 200, then energy fuel 512 is created. Energy fuel 512 is not the only by product of coordinating the after-life with the Architectural Elements 200. The reconfigure, relocate, remove or reuse phase 508 of the Building Components 100 is of critical value in the environmentally safe building of the present invention. Yet still further, the present invention provides, with respect to coordinating 538 the after-life of Architectural Elements 200 the ability to retro-fit or recycle and utilize various Building Components 100 with new products 510. Thus, the present invention provides the opportunity for many decisions with respect to the utilization and coordination of Architectural Elements 200 into the project design.

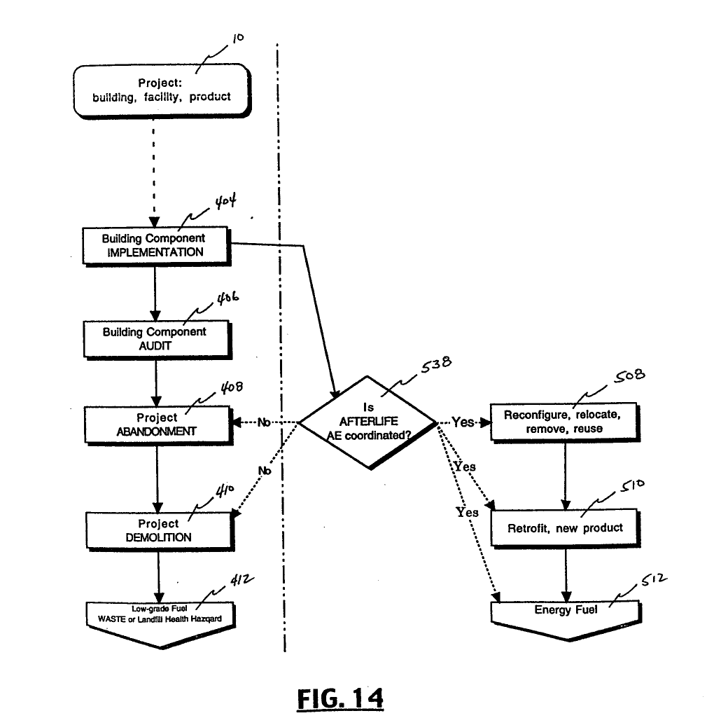

FIG. 14 is an illustration of yet another embodiment of the project system and method of the present invention wherein an existing project 10 is evaluated with respect to being coordinated for Architectural Elements 200 after implementation, construction and re-construction 404. FIG. 14 is yet still another embodiment of the present invention wherein an existing project is evaluated with respect to being coordinated for Architectural Elements 200 after construction. The project 10 is in place and the Building Component implementation 404 has been completed. Typically, a Building Component audit 406 can be provided or performed. Thereafter, the project 10 may be abandoned 408. After abandonment 408, the project 10 can be demolished 410. After demolition 410, low grade waste fuel or landfill health hazard 412 is an end-product. However, in practicing the present invention, the decision can be made to coordinate the Architectural Elements 200 with the after-life of the building 538. If such coordination 538 is performed, it provides the ability to reconfigure, relocate, remove, or reuse elements 508. Still further, the ability to retrofit, recycle, or utilize the Architectural Elements in new products 510 is a possibility for providing enhanced environmental benefits through conservation of our natural resources often at a cost savings. Lastly, the coordination of the after-life with respect to Architectural Elements provides for useable energy fuel from waste 512 while reducing or eliminating the toxic health hazards indicative of the prior art.

FIG. 15 illustrates the classification of project parts, and illustrates determining and documenting the classification of project property, assets, items, things, or parts as a Building Component or an Architectural Element with respect to the project system and method of the present invention.

A determination must be made of whether items are either “inherently permanent” or “relocatable”—The architect, designer, engineer, facility manager, project professional, developer, product manufacturer, or contractor is generally not aware of the full significance of whether or not the assets, items, things, or parts of a project are either “inherently permanent” or “relocatable”; therefore, they make no such distinction in their documentation, nor major effort to conform or transform Building

A determination must be made of whether items are either “necessary for” or “supplemental to” the maintenance and operation of the project—Furthermore, the architect, designer, facility manager, project professional, developer, product manufacturer, or contractor is generally unaware of the full significance of whether or not the assets, items, things, or parts of a project are either “necessary for” or “supplemental to” the maintenance and operation of the project; therefore, they make no such distinction in their documentation, nor effort to conform or transform Building Components into Architectural Elements. While the facts supporting classification as “decorative” may differ from the facts supporting classification as “supplemental,” the classification methods parallel one another. Therefore, they are grouped together as illustrated in FIG. 15.

A determination must be made of whether an asset is inherently permanent—In order to determine if an asset is inherently permanent one asks the following question to aid in making that determinations:
1) Is the asset capable of being moved?
2) Has the asset in fact been relocated?
3) Was the asset “designed” or constructed so that it can be relocated?
4) Owner intent: Are there circumstances that show expected or intended length of affixation?
5) How “easy” is it to remove the asset? This may involve a cost analysis comparison of relocation versus demolition with re-construction.
6) How much damage will the property sustain upon removal of the asset?
7) By what method is the asset attached to the project?

The questions are not order determinative. The questions can be asked in any order with respect to permanent versus relocatable or with respect to necessary versus decorative/supplemental.

Is an asset necessary for the operation or maintenance of a project—To answer the question “is an asset necessary” for the maintenance and operation of the building or project?” is illustrated in FIG. 15 as items 15B and 15C which include considering the following: Using building codes and other standard requirements to determine whether an asset is decorative 508 or supplemental to 506 or necessary to 403 the operation or maintenance of a project as illustrated following with the example of the wall light scone.

Factual analysis—The “factual analysis” 15D is a re-evaluation of the questions and answers of the permanent/necessary analysis 15A, 15B, and/or the necessary analysis 15C in light of extenuating circumstances related to the project and or the project owner and includes a “weighting” of the facts to render a judgement call when the facts may be vague or duplicit. Intangible assets can play a big role in the factual analysis 15D, where they generally play a minor role it weighting of facts in the initial pass through the process. Therefore, it is often helpful to group these facts as tangible or intangible for clarity. In some circumstances these facts must be reanalyzed and reconsidered in light of additional facts. The process may take several iterations of analysis before a decision can be made of whether the asset is a Building Component or Architectural Element. These iterations may involve feeding back to the beginning 15A or some other point in the process (See 401, 504, 15B, 15C), but do so now with greater knowledge about the asset. This may result in the facts being assigned a different weight.

The process generally is to consider a project asset, thing, product, or part, etc. 10 and decide 15A whether or not it is inherently permanent 401 or relocatable 504.

Process: Is asset Permanent? (15A) YES—If it is determined to be permanent 401 then one must decide 15B whether it is “necessary to” 403 or “supplemental to” 506 the operation or maintenance of a project or “decorative” 508. If the asset is permanent 401 and necessary 403 then it is a Building Component 400. However, if it is decided 15B that the permanent asset 401 is supplemental 506 or decorative 508 then a decision must be made based on “factual analysis” 15D to determine whether or not the asset is a Building Component 400 or an Architectural Element 500. For example a wall sconce light that is “attached” in a inherently permanent 401 manner could be determined 15B to not be necessary to the operation or maintenance of the project 403 but rather supplemental 506 or decorative 508. Then a decision based on “factual analysis” 15D will determine whether the wall sconce light is a Building Component 400 or an Architectural Element 500. This “factual analysis” could include review of the basis for decision 15B plus engineering and building code data for minimum lighting requirements to determine if these requirements are met without the light. This would be a “tangible” factual analysis. If so then, barring other facts, the light is not necessary 403, but rather supplemental or incidental 506 to the operation or maintenance of the building and it would therefore follow that the wall sconce light is an Architectural Element 500.

Process: Is asset Permanent? (15A) No, then relocatable—If it is determined “not” to be permanent and therefore “Relocatable” 504 then one must decide 15C whether it is “necessary to” 403 or “supplemental to” 506 the operation or maintenance of a project or “decorative” 508. If the asset is relocatable 504 and supplemental 506 or decorative 508 then it is an Architectural Element 500. However, if it is decided 15D that the relocatable asset 504 is necessary 403 then a decision must be made based on “factual analysis” 15D to determine whether or not the asset is a Building Component 400 or an Architectural Element 500. For example a ceiling tile that is “attached” in a relocatable manner could be determined 15D to be necessary to the operation or maintenance of the project 403 and not supplemental 506 or decorative 508. Then a decision based on “factual analysis” 15D will determine whether the ceiling tile is a Building Component 400 or an Architectural Element 500. This “factual analysis” could include review of the basis for decision 15B plus engineering and building code data for mechanical functions, reflection of lighting, and or acoustical requirements, etc. to determine if these requirements are met without the ceiling tile. This would be a “tangible” factual analysis. If so then, barring other facts, the ceiling tile is not necessary 403, but rather supplemental or incidental 506 to the operation or maintenance of the building and it would therefore follow that the ceiling tile is an Architectural Element 500.

Process: Decorative?—The term “decorative” 508 can imply “not necessary”. If an asset, thing, or part or a project is determine to be “not” necessary to the operation or maintenance of a building then decorative 508 and supplemental 506 are essentially equal terms. However, the term “decorative” also has “artistic” implications that may or may not be necessary to the operation of a building. Where an “artistically decorative” asset, thing, or part of a project is determine to be “necessary” to the operation or maintenance of a building then a factual analysis 15D is required to determine whether the asset is decorative or supplemental.

Note, in some circumstances reversing the order or point of entry or exit in the method will enhance the method.

1. A method of creating a project including a building, facility or product using Building Components and Architectural Elements,
the Building Components defined as, at least one of, components that are inherently permanent, or components that are necessary for the operation or maintenance of the building, and
the Architectural Elements defined as, at least one of, elements that are removeable, reuseable, relocatable, decorative, or supplemental,
the method of creating the project comprising the steps of:
(a) determining the scope of the project such that the project can be defined,
(b) determining if the project is a candidate for Architectural Element coordination,
(c) if the project is not a candidate for Architectural Elements coordination, then the steps:
(1) identifying the Building Components for the scope of the defined project, and
(2) implementing the identified Building Components for constructing the project,
(d) if the project is a candidate for the Architectural Elements coordination, then determining if the design is Architectural Element coordinated,
(e) if the design is not Architectural Element coordinated, then coordinating the design with the Architectural Elements,
(f) if the design is Architectural Element coordinated, then the steps:
(1) identifying the Architectural Elements for the scope of the defined project,
(2) identifying the Building Components for the scope of the defined project, and
(3) implementing the identified Architectural Elements and Building Components for creating the project.

2. The method of creating a project including a building, facility or product using Building Components and Architectural Elements as defined in claim 1 further comprising the step of coordinating pricing with at least one of the Architectural Elements the and Building Components.

3. The method of creating a project including a building, facility or product using Building Components and Architectural Elements as defined in claim 1 further comprising the step of coordinating documentation with at least one of the Architectural Elements and the Building Components.

4. The method of creating a project including a building, facility or product using Building Components and Architectural Elements as defined in claim 1 further comprising the step of coordinating audit with at least one of the Architectural Elements and the Building Components.

5. The method of creating a project including a building, facility or product using Building Components and Architectural Elements as defined in claim 1 further comprising the step of coordinating the project with the assurance standards and with at least one of the Architectural Elements and the Building Components.

6. The method of creating a project including a building, facility or product using Building Components and Architectural Elements as defined in claim 1 further comprising the step of coordinating project afterlife with at least one of the Architectural Elements and the Building Components.

7. The method of creating a project including a building, facility or product using Building Components and Architectural Elements as defined in claim 6 wherein the step of coordinating afterlife further comprises the step of providing for the manipulation of the Architectural Elements selected from the group consisting of reconfiguration, relocation, removal and reuse.

8. The method of creating a project including a building, facility or product using Building Components and Architectural Elements as defined in claim 5 wherein the step of coordinating afterlife further comprises the step of providing for the manipulation of the Architectural Elements selected from the group consisting of retrofit, recycle, and new product.

9. The method of creating a project including a building, facility or product using Building Components and Architectural Elements as defined in claim 5 wherein the step of coordinating afterlife further comprises the step of providing for the manipulation of the Architectural Elements as energy fuel.

10. The method of creating a project including a building, facility or product using Building Components and Architectural Elements as defined in claim 5 wherein the step of coordinating afterlife comprises the steps of
(a) providing for the manipulation of the Architectural Elements selected from the group consisting of reconfiguration, relocation, removal, and reuse,
(b) providing for the manipulation of the Architectural Elements selected from the group consisting of retrofit, recycle, and new product, and
(c) providing for the manipulation of the Architectural Elements as energy fuel.

11. A system for creating a project (including a building, facility or product), the project having a plurality of Building Components which are either inherently permanent or necessary for the operation or maintenance of the building, the improvement being a plurality of Architectural Elements which are at least one of removeable, reuseable, relocatable, decorative and supplemental such that the Architectural Elements can be reconfigured for improving user efficiency, enhancing facility management, reducing construction cost and time, simplifying remodeling construction thereby allowing projects to be rehabilitated that would otherwise be demolished, reducing the employee down-time associated with building remodeling construction and maintenance, reducing the building down-time because remodeling can be done more quickly with less demolition, noise, waste or delay, providing for the easy relocation of equipment or personnel, providing for individualized power circuits which allows for easier relocation of power and lights for reducing the required particular re-balancing of electrical loads, and at least one of separating and identifying the Architectural Elements during the pre-design, design, documentation, implementation, audit or after-life to accommodate future changes in environmentally sensitive or ecologically beneficial manners.
